(19) United States
(12) Patent Application Publication
(10) Pub. No.: US 2004/0004750 A1
(43) Pub. Date: Jan. 8, 2004

(54) Handling assembly and method for fluid processing of ophthalmic lenses

(76) Inventors: Thomas Stevenson, Scotland (GB); Michael Doolan, Bathgate (DE)

Correspondence Address: Katherine McGuire, Bausch & Lomb Incorporated, One Bausch & Lomb Place, Rochester, NY, 14604, US

(21) Appl. No.: 10/240,573

(22) PCT Filed: Mar. 27, 2001
(86) PCT No.: PCT/GB01/01352

(30) Foreign Application Priority Data
Apr. 10, 2000 (GB) 0008756.9

(51) Int. Cl. G02B 26/02

(52) U.S. Cl. 359/228

(57) ABSTRACT

Apparatus and method for fluid processing a plurality of ophthalmic lenses in a tank of fluid includes rotation of the carrier frame holding the lenses in the tank between the first and second stages of fluid processing. The rotation of the carrier frame ensures complete fluid processing of the lenses as well as consistent location of the lenses following removal from the tank.

The present invention generally relates to industrial material handling. More particularly, the present invention relates to a unique handling assembly and method for fluid processing of contact lenses in batch. Typical fluid processing steps in the manufacture of soft contact lenses include hydration of the dry lens to a wet (soft) lens, and extraction of unwanted constituents remaining in the lens. The contact lenses are preferably supported upon a pallet which, when placed in stacked relation with other pallets, enables fluid processing of a plurality of contact lenses in an efficient manner. The inventive handling assembly and method includes fluid processing in a bath wherein stacked pallets of contact lenses are removably held in an open carrier frame. Means are provided for the timed rotation of the frame and lens assembly within the bath which ensures complete processing of the lenses and controls lens migration within the stacked pallets during processing. The invention is also applicable to other types of ophthalmic lenses requiring fluid processing; for example, spectacle and intraocular lenses.

Static cast molding of contact lenses is known. See, for example, U.S. Pat. No. 5,466,147 issued to Bausch & Lomb Incorporated, the entire reference of which is incorporated herein by reference. A single mold unit comprises a female mold section having a concave optical she and a male mold section having a convex optical surface. The female and male mold sections are complimentary shaped and mateable to form a lens-molding cavity between the facing concave and convex optical surfaces of the female and male mold sections, respectively.

The basic process for cast molding a lens is as follows. A quantity of liquid lens material (monomer) is dispensed into the concave optical surface of the female mold section and the male mold section is seated upon the female mold section with the concave and convex surfaces thereof facing one another to form a lens-shaped mold cavity. The joined female and male mold sections form a single mold unit which is subject to a curing cycle (e.g., by thermal or UV radiation) thereby causing polymerization of the lens material in the mold cavity. Once the lens material has cured, the male and female mold sections must be separated to retrieve the cured lens.

The opening or release of the mold sections must be carried out in a manner which will not harm the delicate lens. Once the lens has polymerized in the mold cavity, the lens and any lens flash will have an adhesive bond to the opposite concave and convex mold surfaces. Thus, the release of the male mold section from the female mold section must be of a force strong enough to break the adhesive bond of the lens and lens flash to the opposing mold surfaces, yet not so strong or haphazard that the optical surfaces of the lens are harmed by the release process. Should the lens crack or be otherwise damaged during the mold release process, the lens must be scrapped, thereby lowering the output yield and increasing manufacturing costs.

Once the mold sections have been separated, the lens must be released from the mold section on which it is retained. Both wet and dry release methods of lens release have been proposed in the prior art. The present invention addresses the wet release method. In wet lens release methods, an aqueous solution is used to wet the hydrophilic lens which absorbs water and swells, causing the lens to separate from the mold surface. Once the lens has hydrated and is released from its associated mold surface, the lens becomes a free-floating body in the hydrating fluid. If this process is carried out in a bath, there must thus be some means to contain the hydrated lens, yet not inhibit the access of the hydrating fluid to the interior of the mold and lens. Otherwise, the lenses must be “fished out” from the hydration bath using tweezers, a very labor-intensive prospect.

Typically, the molds in which the lenses have been cured are carried on a support pallet in a predetermined array. Once the molds have been opened, the mold sections carrying the adhered lenses are transferred to a lens release station as discussed above.

It is desirable to be able to batch process contact lenses through different stations of a manufacturing process for efficiencies of manufacturing. It is thus desirable to be able to fluid process contact lenses in batches. Various methods of batch processing contact lenses through a fluid processing step have been proposed. The handling of the lenses during fluid processing include processes where the lenses are still in the mold or, alternatively, the lenses have been transferred to a different receptacle. It is furthermore known to use a bath process where batches of lenses may be submerged in a bath of fluid. It is also known to use sequential baths to ensure adequate fluid processing of the lenses. Alternatively, fluid may be applied to each individual lens in metered amounts, followed by extraction of the fluid from the mold section or receptacle without damaging the lens. This particular method may be accomplished with the apparatus and method of spending U.S. application Ser. No. 09/140,925 filed on Aug. 27, 1998, and Ser. No. 08/936,944 filed on Sep. 3, 1998, both of which are assigned to the present assignee herein, Bausch & Lomb Incorporated.

An example of carriers for bath hydration may be seen in copending UK application no. ______ filed on Mar. 31, 2000 and which is assigned to the present assignee herein. In this method, a pallet containing an array of female mold sections having respective lenses adhered thereto is stacked on a pallet having a like array of empty male mold sections thereon. An empty pallet is stacked upon the female pallet to prevent the male mold sections from falling from the female pallet during hydration. The stack of three pallets form a single unit for bath hydration, and multiple units may be stacked together and placed in a carrier for submerging in the bath. The pallets are cooperatively configured such that the female and male mold sections are spaced by an amount sufficient to allow fluid to enter between the facing sections to reach the lens, but spaced small enough so as to prohibit the hydrated, loose lens from escaping from between the respective female and male mold sections. This method is especially geared toward a manufacturing method where the male mold section is used for packaging of the contact lens as seen in U.S. Pat. No. 5,573,108, also of common ownership with the instant application for patent. While the lens hydration method disclosed in the U.K. application has been found very efficient, it also has certain drawbacks including the inability to control lens movement after it has released from its associated mold section in the bath. This, in turn, can lead to occurrences of lenses sticking upward from its associated mold at posy-hydration disassembly of the pallets, as well as lenses missing from their respective molds, or two lenses appearing in a single mold, for example. It would thus be desirable to overcome the deficiencies of this method of lens hydration.

Another example of lens hydration carriers may be seen in U.S. Pat. No. 5,080,839 (Johnson & Johnson Vision Products, Inc.). The '839 patent discloses a lens transfer plate which first picks an array of female mold sections together with their associated lenses to form a first hydration carrier. The first hydration carrier is submerged in a bath to hydrate the lens through fluid passages extending through the center of each lens pick-up. The mold section is then released, with the lens remaining with the lens transfer plate through surface tension. The lens transfer plate and lens assembly then couple to a hydrating base which has a like array of hydrating receptacles each having their own fluid passages for passing hydrating/extraction fluid to the lens contained therein. Once so treated, the lenses must be picked from the hydration base and transferred to yet another receptacle for further downline processing such as inspection and packaging, for example. The '839 method and apparatus is rather complex in that it requires many complex robotic handling stations, as well as many handling components and carriers.

It is thus clear that lens handling is a critical parameter in the contact lens manufacturing line. Since contact lenses are extremely delicate, small articles of manufacture having precise optical surf they must be handled with extreme care so as to not damage or otherwise mishandle the lens resulting in increase costs to the manufacturing operation.

The present invention addresses the need for an efficient method of batch-processing contact lenses through various fluid processes. The invention provides a semi-automatic rotation assembly and method for the batch processing of a plurality of contact lenses in a bath. Following the curing operation, the molds are separated. The lenses remain adhered to one of the pair of mating mold sections in which they were cast, with each mold section having respective lenses adhered thereto being supported upon a first mold pallet. A second mold pallet is provided for supporting the complimentary mold sections in a like array. The first and second pallets are stacked upon each other in a manner orienting the lens between the mold sections of the first and second pallets. A third, empty pallet is stacked upon the second mold pallet to prevent disengagement of the mold sections from the second pallet. The first, second and third pallets constitute a single lens processing unit, and a plurality of such processing units may be stacked upon each other while still maintaining the sparing needed to ensure complete fluid processing of the lenses contained therein.

A stack of lens processing units are removably inserted into a carrier frame for submersion in the processing bath. In the preferred embodiment, the carrier frame presents the pallets in a vertical orientation as they are submerged into the bath which creates a nominal direction of fluid flow up through the adjoining pallets and the facing mold sections which contain the lenses. After a predetermined amount of time, the carrier frame is rotated 90° while still submerged in the bath to re-position the pallets in a horizontal orientation. This re-positioning of the pallets causes the now released lenses to migrate to the opposite mold section in the adjoining pallet which ensures correct lens positioning upon disassembly of the processing units. Once rotated, the carrier is kept in the bath for a farther predetermined amount of time until fluid processing of the lenses is complete.

Semi-automatic means are provided for rotation of the carrier frame within the bath. Such means may be in the form of a pick-and-place unit which is attached to an overhead gantry above the bath The pick-and-place unit is operable by an operator to engage cooperative features on the carrier frame for simplified handling of the carrier frame within the bath.

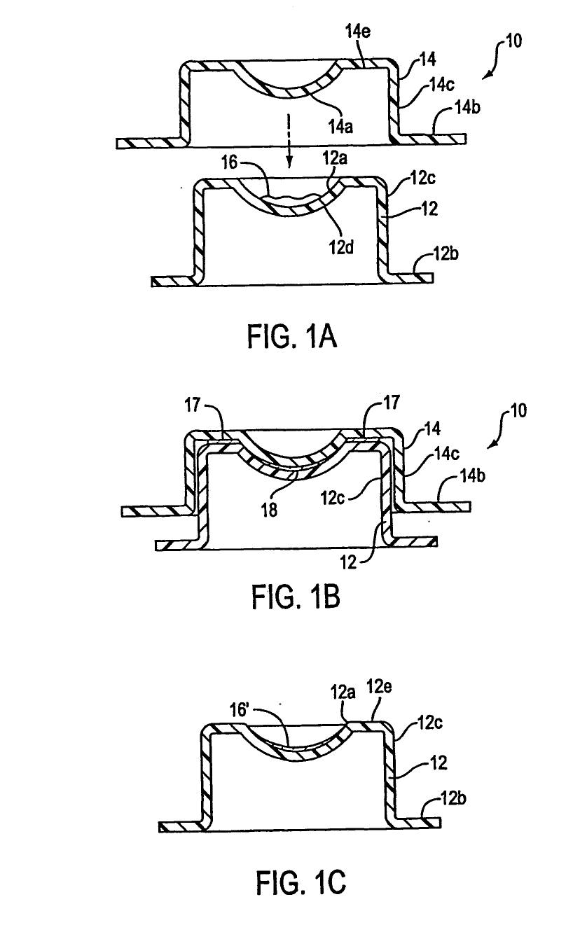

FIG. 1A is a cross-sectional view of a contact lens mold comprising a female mold section having a concave molding surface and a complimentary male mold section having a convex molding surface, in spaced relation above the female mold section;

FIG. 1B is the view of FIG. 1A except that the male mold section has been seated upon the female mold section in the intended manner to define a lens-shaped molding cavity therebetween;

FIG. 1C is a cross-sectional view of the female mold section following curing of a lens therein and removal of the male mold section;

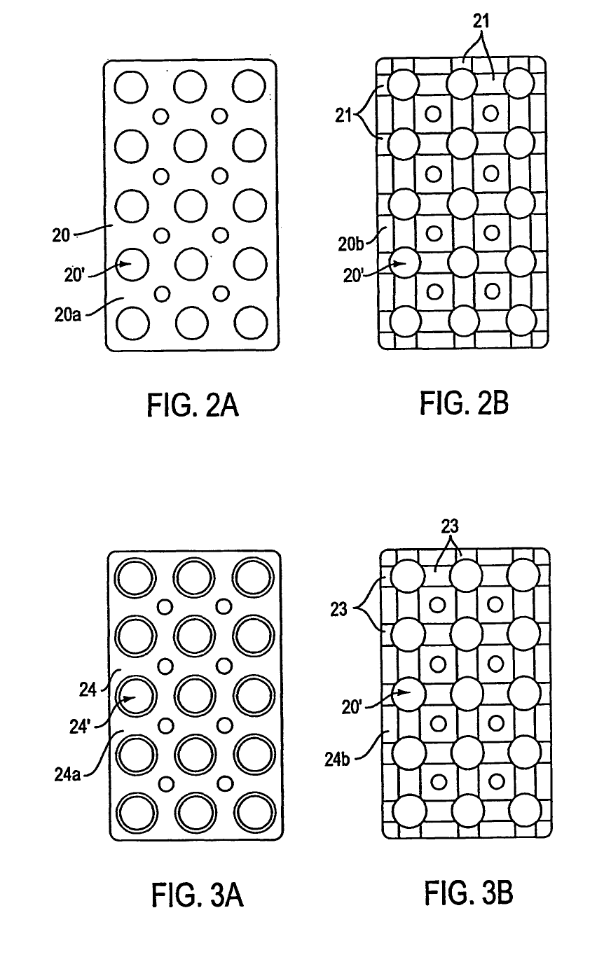

FIGS. 2A and 2B are top and bottom plan views, respectively, of a female mold pallet;

FIGS. 3A and 3B are top and bottom plan views, respectively, of a male mold pallet;

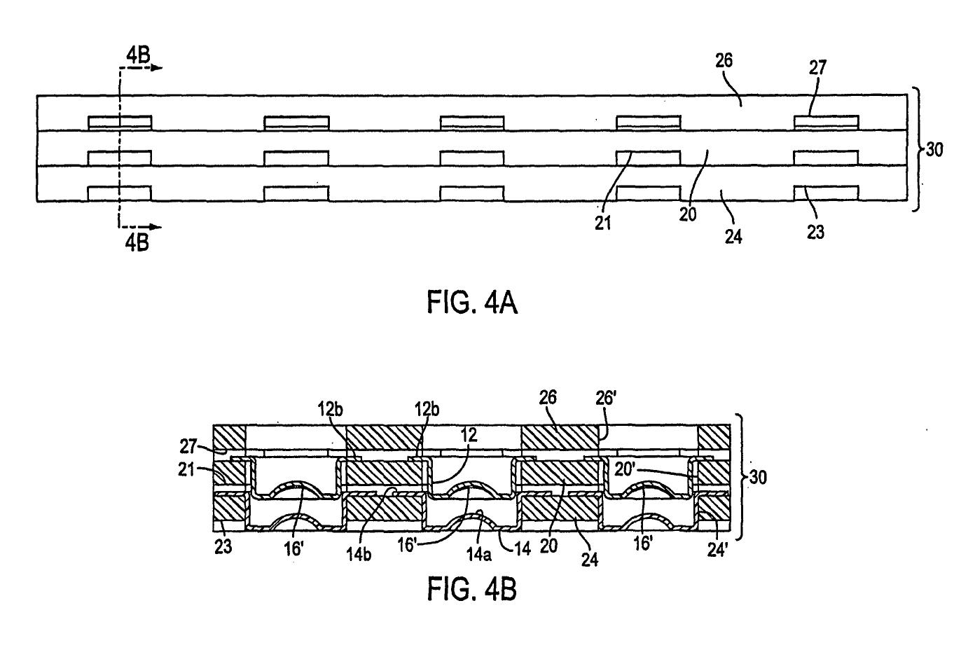

FIG. 4A is a side elevational view of three stacked pallets forming a single processing unit for fluid processing an array of contact lenses contained therein;

FIG. 4B is a cross-sectional view as taken generally along the line 4B-4B in FIG. 4A;

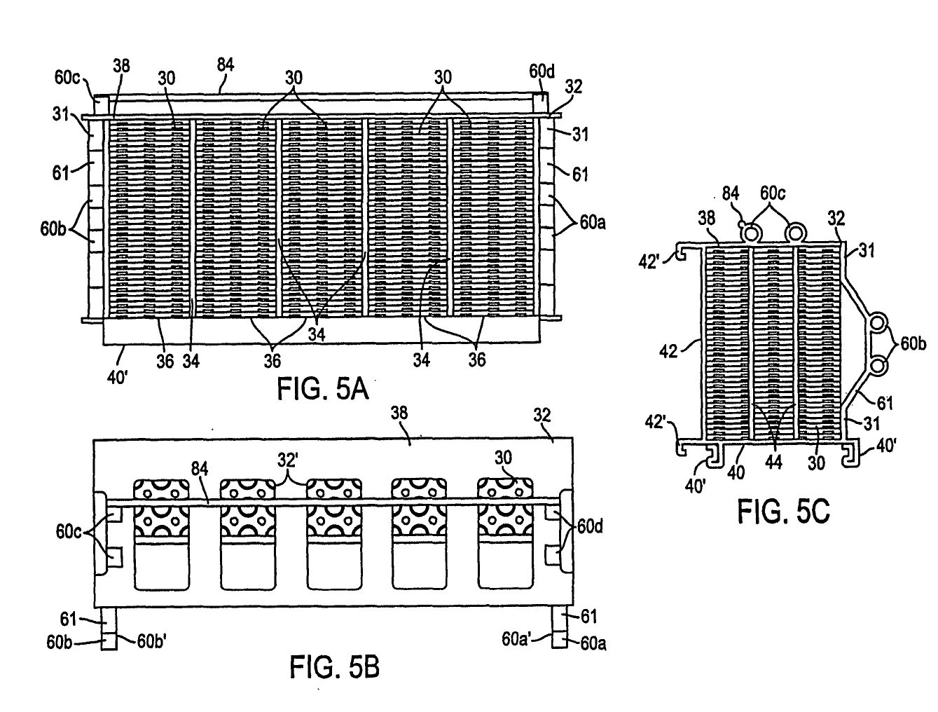

FIG. 5A is a front elevational view of the carrier frame of the invention into which five columns of stacked pallets have been removably inserted for fluid processing;

FIG. 5B is a top plan view thereof;

FIG. 5C is a side elevational view thereof;

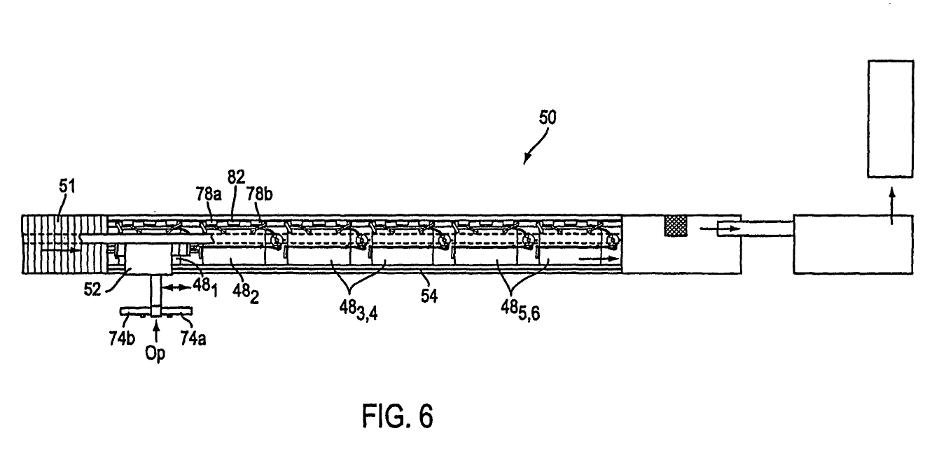

FIG. 6 is a top plan view of a lens fluid processing station according to a preferred embodiment of the invention;

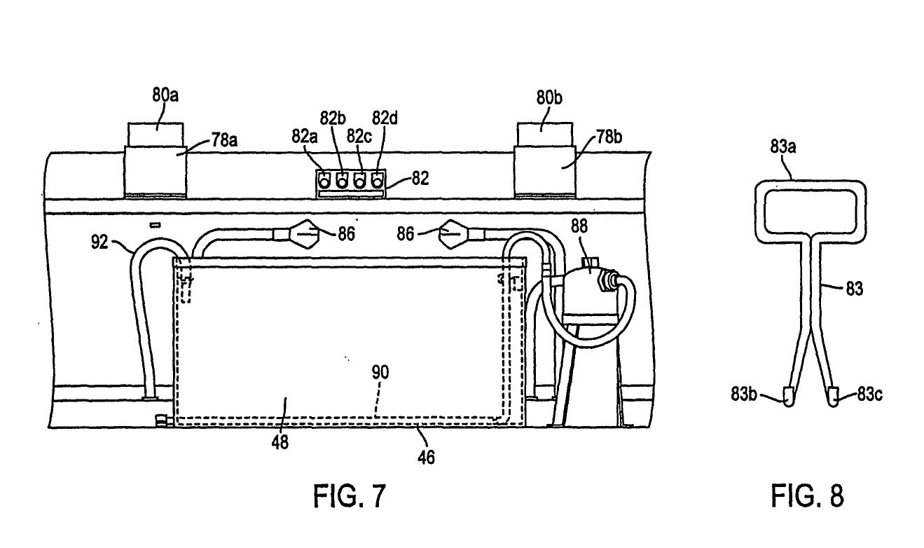

FIG. 7 is a front elevational view of a single fluid processing tank of the invention;

FIG. 8 is a top plan view of a grappling hook for use in assisting the rotation of the carrier frame in the tank;

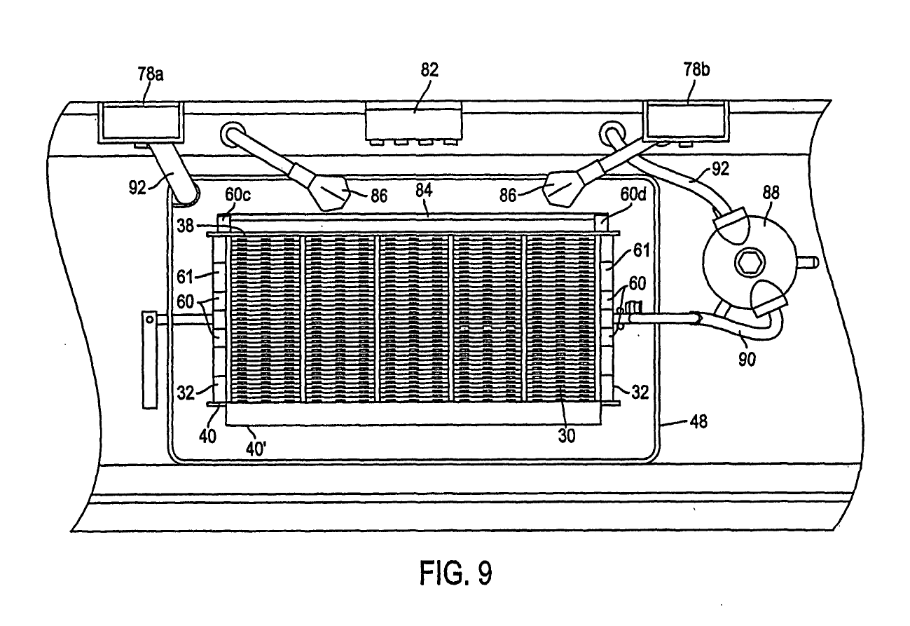

FIG. 9 is a top plan view of a fluid processing tank showing the carrier frame in its initial processing position within the tank where the pallets are held in a vertical orientation in the tank;

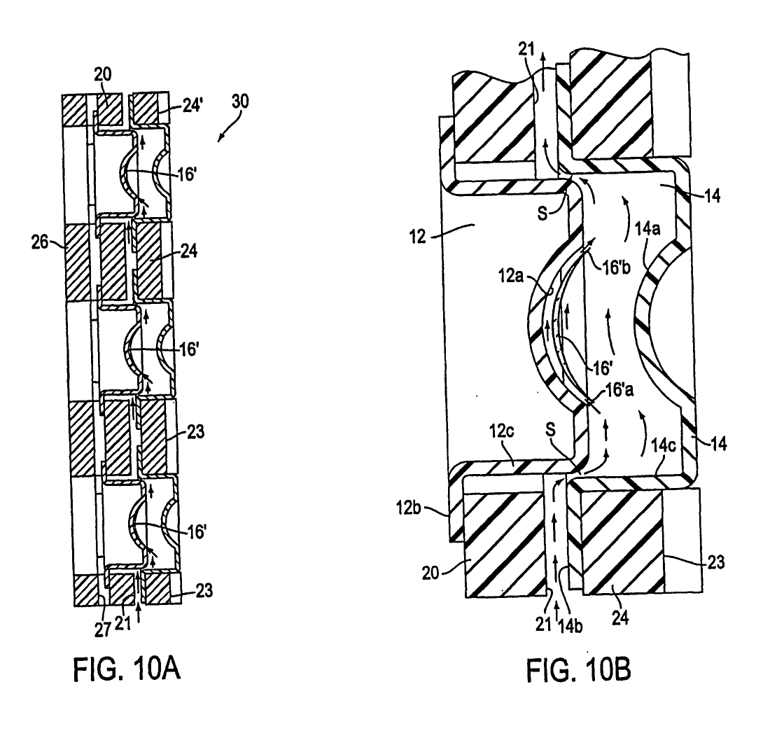

FIG. 10A is an end, cross-sectional view of a stack of three pallets comprising a single fluid processing unit showing the unit in its initial vertical orientation within the tank of FIG. 9;

FIG. 10B is an enlarged detail of FIG. 10A to show the fluid flow path between the facing pairs of female and male mold sections;

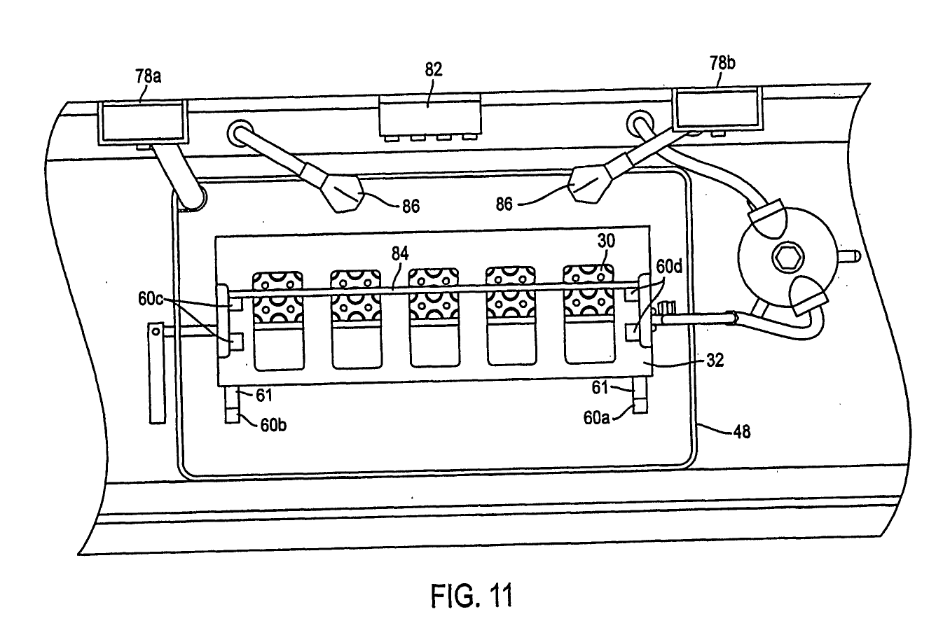

FIG. 11 is the view of FIG. 9 except that the carrier frame has been rotated 90° from its initial position in the tank so that the pallets are now in a horizontal orientation within the tank; and

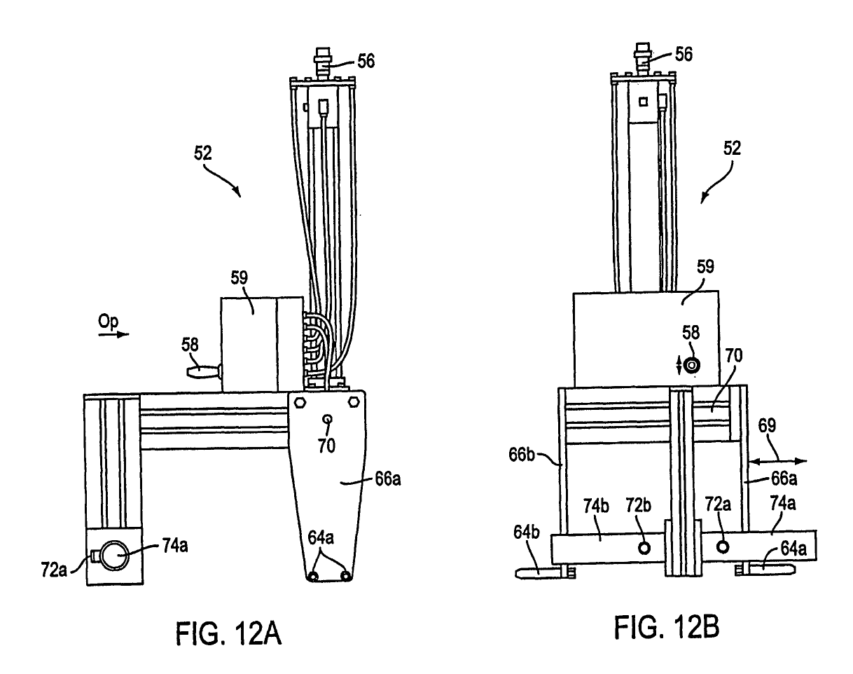

FIGS. 12A and 12B are side and front elevational views, respectively, of the overhead pick-and-place unit for handling the carrier frame into and out of the tank.

Referring now to the drawing, there is seen in FIGS. 1A and 1B a representative prior art contact lens mold unit 10 having a female mold section 12 and a complimentary male mold section 14 having respective concave and convex optical molding surfaces 12A, 14A. To mold a lens, a quantity of liquid lens material 16 (e.g., monomer) is dispensed into the female mold section 12 and the male mold section 14 is seated upon the female mold section which creates a lens-shaped mold cavity 18 defined by the facing optical mold surfaces 12A, 14A thereof. Each mold section 12,14 includes a respective annular wall section 12C,14C which allows a sliding piston/cylinder type action as the male mold section 14 is seated upon the female mold section 12. Each mold section further includes an annular flat section 12E,14E extending radially outwardly of the associated mold surface 12A,14A, meeting associated annular wall portions 12C,14C at the uter perimeter of the annular flat section 12E,14E, respectively. Each mold section 12,14 further includes an annular flange 12B,14B extending radially outwardly of associated annular wall sections 12C,14C.

The mold sections 12, 14 are typically injection molded using polypropylene, polystyrene or polyvinylchloride, for example, and are used only once to mold a single lens due to degradation of the optical surfaces thereof after molding of a lens therein. The quantity of monomer 16 dispensed in female mold section 12 is sufficient to permit a slight overflow of the monomer upon seating the male mold section 14 thereon which ensures a complete fill of the cavity 18 to the periphery where the lens edge will form. Upon fully seating the male section upon the female section, the excess monomer flows radially outwardly of the mold cavity 18. Upon curing, this excess monomer forms an annular flash ring 17 between annular flat sections 12A 14E, commonly referred to as a “monomer ring” in the art.

Thus, once a mold unit 10 has been filled and capped as seen in FIG. 1B, it is subjected to a curing cycle which polymerizes the monomer inside the mold cavity 18. Typical contact lens curing methods include UV radiation and/or thermal (e.g., oven) curing. An accurate cure profile, whether using UV and/or thermal means to effectuate the cure is determinable according to the mold and monomer type by those skilled in the art, and may also be determined by trial and error without undue experimentation. Once curing is complete, the male mold section 14 is separated from the female mold section 12 to reveal the lens 16′ which has formed therein (FIG. 1C). The mold release process must break the adhesive bond between the mold sections, yet not damage the lens which remains on one of the mold surfaces. In the preferred embodiment described and illustrated herein, the lens 16′ remains an the female concave optical surface 12A at mold release as seen in FIG. 1C, and the lens flash 17 remains with the associated male mold section 14 (not separately shown), although this may vary depending on the specific mold configurations being used as desired. Thus, immediately following mold release, The lens 16′ remains bonded to female mold surface 12A and is in the dry, rigid state (i.e., it has not yet been hydrated). A suitable mold release apparatus and method may be seen in copending U.K application No. ______ which was filed on Mar. 31; 2000 and is of common ownership herewith. In _____ the application, once separated, the male and female mold sections are picked and placed upon respective male and female pallets such as pallets 20 and 24 seen in FIGS. 2A,B and 3A,B hereof. Pallets 20,24 each have opposite top and bottom surfaces 20A,20B and 24A,24B, respectively. Additionally, a series of inter-connecting grooves 21,23 are formed in the bottom surfaces 20B,24B thereof, respectively, which form fluid passages during fluid processing of the molds in the manner to be described.

It is noted that pallets 20,24 may be identical or vary slightly in configuration as needed to accommodate the configuration of the particular mold sections employed in the manufacturing process For example, pallet 24 may include a bevel along the perimeters of openings 24′ to accommodate the respective male mold sections 14 held therein. Thus, as described in co-pending application No. ______, once the molds have been cured and cracked open, the female mold sections 12 are picked and placed into respective openings 20′ of female mold pallets 20, and the male mold sections 14 are picked and placed into respective openings 24′ in male mold pallets 24.

Referring to FIGS. 4A and 4B, once the mold sections have been positioned in their respective pallets as described above, the female and male pallets 20,24 are stacked one upon the other with an empty third pallet 26 being placed over the side of the female pallet 20 opposite the male pallet 24. The stacked female, male and empty pallets form a single fluid processing unit 30 for an array of lenses 16′. The thirds empty pallet 26 is configured substantially the same as the female or male pallet to include openings 26′ and interconnecting grooves 27 to form fluid passages. Empty pallet 26 serves the purpose of preventing the female mold sections 12 from falling out of respective openings 20′ during handling by pallet 26 engaging the annular flanges 12B of each female mold section 12. When the female, male and empty pallets are stacked in this manner, the female and male mold sections 12,14 are positioned with the respective molding surfaces 12A,14A thereof in facing yet spaced relation. The spacing of the mold sections in this manner creates passages for fluid to enter through grooves 21,23 and between the facing mold surfaces 12A, 14A thereof, respectively, with the fluid thereby reaching the lens 16′ held therebetween. However, the spacing should not be so large so as to permit the lens 16′ to migrate out from between the mold surfaces 12A, 14A. More detailed discussion of fluid flow through the stacked pallets is set forth below with regard to FIGS. 10A, 10B.

As stated above, a plurality of stacked lens processing units 30 is prepared for fluid processing by first being removably inserted into a carrier frame 32 as seen in FIGS. 5A-C, 9 and 11. The carrier five 32 is constructed of a rigid material (e.g., stainless steel) and has four spaced, parallel wall units 34 therein defining five separate openings into which stacks of pallets/processing units 30 may be removably inserted, although it is understood that the overall size of the carrier 32 and number of openings 36 may vary as desired. In the embodiment shown and described herein, the carrier frame 32 can hold about 60 processing units (180 pallets). FIG. 5A shows a front elevational view of carrier frame 32 where the openings 34 are facing a worker who inserts the stacks of processing units 30 therein. The carrier frame 32 further includes a top wall 38, bottom wall 40, rear wall 42 and side bars 44 which together form an open frame allowing for the free flow of fluid therethrough. Top wall 38 is seen to include spaced openings 32′ which align with the five columns of stacked units 30 positioned within carrier frame 32. Additionally, rear wall 42 and bottom wall 40 each include legs 42′ and 40′, respectively, which space the rear and bottom wall 42,40 from the bottom wall 46 of the processing tank 48 (FIG. 7) when submerged therein. These features further contribute to the even flow of fluid through the carrier frame 32.

As seen in FIG. 6, a preferred embodiment of a fluid processing station 50 according to the invention is seen to include six tanks 48₁₋₆ each of which contain about 80 liters of processing fluid (e.g., water to hydrate the lenses), although the number of tanks and quantity of fluid used in each tank may also vary as desired. In the embodiment of FIG. 6, six carrier frames containing lenses may be processed at a time, one in each tank 48. The carrier frames 32 are transported by a conveyor 51 to a position adjacent the first tank 48₁. The carrier frames 32, having been populated with processing units 30, are picked from conveyor 51 for submersion in a respective tank 48. A semi-automatic pick-and-place unit 52 (hereafter “P&P unit”) which slidably mounts to an overhead track/gantry 54 which extends above and along the line of six tanks 48₁₋₆. (FIGS. 6, and 12A,12B).

The operation of the P&P unit 52 is as follows. The P&P unit 52 is preferably pneumatically controlled and includes an extensible/retractable shaft 56 which mounts to gantry 54 in a manner allowing for selective sliding movement of unit 52 along gantry 54. An operator stands in facing relation to the P&P unit 52 indicated by arrow “Op” and depresses lever 58 and left button 72B which connect to controls at box 59 causing shaft 56 to extend, thereby lowering P&P unit 52 to a position adjacent the carrier frame 32 on conveyor 51. As seen in FIGS. 5A-C, a pair of lifting rings 60 are provided at either end of the frame side edges 31 via an outwardly curved bracket 61. The carrier frame 32 is presented on conveyor 51 on its back wall 42 such that the front openings 36 are facing upwardly. The carrier frame 32 will be picked and placed by P&P unit 52 while maintaining this orientation so that the pallets/processing units 30 are in a vertical orientation as they are submerged in the bath (see also FIG. 9).

Referring again to FIGS. 6 and 12A,B, P&P unit 52 is seen to further include pickup fingers 64A,64B mounted to spaced, parallel side walls 66A,66B of unit 52, respectively. Pickup fingers 64A,64B are configured to freely slide through respective lifting rings 60A,60B to engage and lift a carrier frame 32 with the pallets in the initial, vertical orientation described above. To facilitate the selective engagement and disengagement between the pickup fingers 64A, and lifting rings 60A,B, at least one of the side walls 66A is mounted to a linear actuator 70 which permits the side wall, and hence also the pickup fingers 64A mounted thereto, to reciprocate toward and away from the other set of fingers 64B in the direction of arrow 69 seen in FIG. 12B. Movement of the linear actuator 70 is controlled by the operator manually depressing buttons 72A,72B on handles 74A,74B, respectively, which also connect to control box 59. The operator also uses handles 74A,74B to manipulate the positioning of P&P unit 52. Thus, to pick a carrier frame 32 from conveyor 51, the operator positions the P&P unit 52 adjacent the carrier frame 32 with the actuator 70 in the fully retracted position as shown in FIG. 12B. The operator uses handles 74A,74B to align fingers 64A,64B with lifting rings 60A,60B, respectively. In this position, fingers 64A,64B will be located between rings 60A,60B and face toward the inside edges 60A′60B′ thereof (FIG. 5B). Once aligned in this manner, the operator depresses buttons 72A,72B to cause actuator 70 to extend (moving to the left along arrow 69 in FIG. 12B). As actuator 70 extends, fingers 64A,64B slide through rings 60A,60B. Once the fingers have extended through the lifting rings, the operator releases buttons 72A,72B and lifts lever 58 and depresses left button 72B to retract shaft 56, thereby raising P&P unit 52 and the carrier frame 32 together. It is noted that the requirement of simultaneous left button activation is in accordance with worker safety regulations which require use of both hands to operate P&P unit 52.

With carrier frame 32 having been picked and raised, the operator moves P&P unit 52 along gantry 54 to a position over the desired tank 48₁₋₆, and then depresses lever 58 to lower P&P unit 52, and thus also carrier frame 32, into the tank. The top plan view of FIG. 9 Shows the carrier frame 32 submerged in a tank 48 in the initial position of pallets/processing units 30 in a vertical orientation. Referring to FIGS. 10A and 10B, fluid flow is shown through the pallets/processing unit 30 while in this vertical orientation, and particularly between pallets 20,24 to reach and process lenses 16′ held therebetween. (Empty pallet 26 is not shown in FIG. 10B for clarity). Fluid flow is represented by the directional arrows and fluid is seen to pass through the space “S” (FIG. 10B) defined between the respective cylindrical walls 12C,14C of each mold set 10. Fluid is thus allowed to pass freely between mold sections 12,14 to reach a respective lens 16′ therebetween. As seen best in FIG. 10B, the vertical orientation of the pallets 20,24 orient the mold surfaces 12A,14B and the lens 16′ in a similar vertical orientation which extends generally parallel to the path of fluid flow as the pallets are submerged into the tank of fluid. Thus, as the carrier frame is lowered into the tank, the fluid flows into the carrier frame in the opposite direction, i.e., in an upward direction starting at the bottommost most part of the carrier frame which hits the fluid in the tank first. The vertical orientation of the mold surfaces and lens 16′ means that fluid will flow across the lens from the lower edge 16′A to the opposite, upper edge 16′B thereof. This direction of fluid flow across the lens reduces the chance that air bubbles will become trapped between the mold surfaces which would impede complete fluid processing of the lenses 16′.

Once the carrier frame 32 has been fully submerged in a respective tank 48, the P&P unit 52 is disengaged from the crier frame by the operator again depressing buttons 72A,72B which causes actuator 70 to retract, resulting in withdrawal of fingers 64A from lifting rings 60A of the carrier frame. The operator may then manipulate P&P unit 52 using handles 74A,B to withdraw the opposite fingers 64B from lifting rings 60B. Lever 58 is lifted, thereby raising P&P unit 52 clear of the carrier frame 32 and respective tank 48. The operator may then slide the P&P unit 52 along gantry 54 to continue processing carrier frames 32 through station 50.

The processing operation of each tank 48 is carried out as follows. Should a fluid processing line such as line 50 be used to process more than one type of lens, it would be desirable to have means for the station to be able to distinguish between the different types of lenses as they are presented for processing. This is because different types of lenses (e.g., negative power versus positive power lenses) typically require different amounts of fluid processing time. Thus, in the preferred embodiment of the invention described herein, each carrier frame 32 includes a single lot card which indicates the specifications of the lenses 16′ associated with a respective carrier frame 32. When a carrier frame 32 is on conveyor 51 and ready for pickup by P&P unit 52, the operator first takes the lot card from the carrier frame 32, determines whether the lenses are positive or negative power (or other desired parameter), and then places the lot card in the correct holder 78A or 78B which is provided at the tank in which the carrier frame is to be processed (see FIG. 7). If the lot card indicates a positive lens power, the lot card 80A is placed in holder 78A Conversely, if the lot card indicates a negative power, the lot card 80B is placed in the other holder 79B. The fluid processing times for a positive power lens is different than the processing times for a negative power lens. A timer mechanism (not shown) is connected to one or both of the card holders 78A, 78B which is tripped upon placing of the respective card 80A,80B therein. For example, a certain negative power lens requires “X” units of time in the tank and a certain positive power lens requires “X+N” units of time in the tank. The timer mechanism may be defaulted to “X” units of time, and if a negative power card is inserted in holder 78B, the timer will run for “X” units of time. However, should a positive power card 80B be presented, it is inserted into holder 78B, and a switch (not shown) positioned within the holder will be tripped by the insertion of the card therein, causing the timer to add “N” units of time to the “X” units of time already programmed.

A control box 82 is provided at the tank 48 which signals the operator of the processing status of the tank and carrier frame 32 held therein. The control box 82 includes a plurality of buttons and signal lights 82a-d indicating the different processing stages of the tank, Sounds/alarms may also be used for this purpose either separately of or in conjunction with the signal lights. Further details of the processing stages of each tank and operation of the buttons and signal lights in conjunction therewith is as follows.

As previously mentioned, the present invention provides for rotation of the carrier frame 32 within the tank to improve the fluid processing of the lenses held in the carrier frame. In the preferred embodiment of the invention, the carrier frame is placed in the tank with the pallets/processing units 30 in the vertical position as seen in FIG. 9 and as described above. Once the carrier frame has been fully submerged in the tank in this initial position, the operator presses the first bottom 82a on control box 82 which is the “start/stop” button of the timer mechanism. The carrier fire is left undisturbed in the tank during the first stage of the timer mechanism which, as stated above, may be defaulted to the required units of time “X”. If a positive power card has been inserted in holder 78B, the switch positioned therein is tripped, thereby causing the timer to run for “X+N” units of time. In the preferred embodiment herein, X=15 minutes and X+N=20 minutes, although this may of course vary depending on the particular fluid process being used and the requirements of the lenses being so processed.

Once the first stage of the timer has passed, the signal light 82b will activate instructing the operator to rotate the carrier frame within the tank. The operator first depresses button 82A to stop the timer. The rotation of the carrier frame 32 within the tank is performed manually by the operator with the assistance of a grappling hook 83 (FIG. 8) having a handle 83A and bifurcated hooked portions 83B,C. It is desired to rotate the carrier frame 90° from its initial vertical positioning in the tank described above such that each mold pair has the male mold section 14 beneath its associated female mold section 12. To do this, the operator uses grappling hook 83 and engages the rod 84 which extends between lifting rings 60C and 60D and pulls the carrier frame in a direction toward him/herself which results in the carrier frame being rotated such that the top wall 38 thereof is now facing upwardly as seen in FIG. 11.

Once the carrier frame has been rotated, the operator again depresses button 82a to set the timer for the second stage of fluid processing. In the embodiment described herein, the timer runs for the same amount of time as in the first stage of processing. Thus, for a negative power lens, the total time of fluid processing will be 15+15=30 minutes total, and for a positive power lens, the total time would be 20+20=40 minutes total. The carrier frame is again left undisturbed in the tank during this second stage of fluid processing At the end of the second stage, signal light 82c is activated instructing the operator to remove the crier frame 32 from its associated tank. Removal of the carrier frame is executed in the reverse manner of submersion of the carrier frame within the tank using the P&P unit 52.

The rotation of the carrier frame within the tank as explained above improves the overall fluid processing of the lenses within the carrier frame. More particularly, the initial vertical orientation of the pallets/processing units in the tank as seen in FIGS. 10A,10B creates optimum fluid flow across the lenses which also impedes the formation of trapped air bubbles with would impede total fluid processing of the lenses. The duration of the first stage of processing is selected so that the lenses are partly hydrated yet still adhered to the respective female mold surface 12A. The carrier frame is rotated 90° to the horizontal orientation of the pallets/processing units 30 seen in FIGS. 4B and 11 with the male mold sections 14 positioned beneath its associated female mold section 12. It is preferred that the carrier frame remain submerged in the tank during rotation thereof.

As the lenses are further hydrated during the second stage of fluid processing, the lenses will detach from their respective female mold sections 12 and float/migrate to the associated male mold surface 14A with the concave surface of the lens (the posterior surface which lies against the eye) engaging the convex surface 14A of the male mold section 14. The surface tension created between the cooperative sues of the wet lens and male mold section contributes to the lenses consistently locating on the male mold section following hydration and disassembly of the processing units 30. Further, the chance of a lens missing from a mold or migrating to another mold during fluid processing is substantially eliminated by the inventive process disclosed herein.

Other details of the tank are as follows. One or more fluid nozzles 86 are provided to fill tank 48. A filter 88 is provided to continuously filter the fluid in the tank during the first and second stages of fluid processing (i.e., any time the timer is activated). The filter includes an inlet line 90 drawing fluid from the bottom 46 of the tank FIG. 7), and an outlet line 92 circulating fluid back into the tank. In the preferred embodiment, a tank is drained and refilled every 12 hours of operation. The fourth signal light 82d on the control box activates to instruct the operator when it is time to drain and refill the tank. A suitable pump for the tank circulates the fluid at a rate of 35 liters/minute. A suitable filter for the tank is a 0.45 micron carbon filter. In the case where the fluid processing is hydration of the lenses, the fluid in the tank is water, although it is understood that the invention is applicable for virtually any type of fluid processing of ophthalmic lenses in a bath (e.g., extraction using an alcohol bath).

What is claimed is:

1. A method for fluid processing a plurality of ophthalmic lenses in a tank of fluid including a plurality of fluid processing units in which said lenses are removably located during said fluid processing, said method comprising the steps of:
a) providing a carrier frame in which said processing units are removably inserted;
b) submerging said carrier frame and processing units in said tank of fluid with said processing units oriented in a substantially vertical position;
c) commencing a first stage of fluid processing wherein said processing units are submerged in said tank for a first predetermined amount of time;
d) rotating said carrier frame and processing units at least 90° whereby said processing units are rotated from said substantially vertical position to a substantially horizontal position in said tank;
e) commencing a second stage of fluid processing wherein said processing units are submerged in said tank for a second predetermined amount of time; and
f) removing said carrier frame and said processing units from said tank

2. The method of claim 1 wherein said lenses are adhered to a respective mold section in which the lenses were cured prior to being placed in said processing unit and carrier frame.

3. The method of claim 2 wherein said mold section is a female mold section having a concave molding surface to which said respective lens is adhered prior to being submerged in said tank.

4. The method of claim 3 wherein said female mold section each have an associated male mold section having a convex molding surface, said female mold surface being in facing yet spaced relation to said male molding surface when in an associated processing unit, said spacing being sufficient to permit fluid to flow between said female and male molding surfaces when said processing units are submerged in said tank.

5. The method of claim 4 wherein said female mold sections are removably positioned on a female mold pallet, and said male mold sections are removably positioned on a male mold pallet, and wherein said female and male pallets are placed in stacked, alternating relationship in said processing units.

6. The method of claim 5, and further comprising a third pallet which is placed in covering relation to a respective male mold pallet opposite a respective female mold pallet, and wherein a single one of said processing units comprises a stack of one female mold palled one male mold pallet, and one third pallet.

7. The method of any one of claims 4, 5 or 6, wherein said male mold sections lie beneath the associated said female mold sections when said processing units are rotated to said horizontal positions in said tank.

8. The method of any preceding claim, wherein said carrier frame remains submerged in said processing fluid during rotation of said carrier frame in said tank.

9. The method of any preceding claim, and further comprising means for filtering and circulating said fluid in said tank during said first and second stages of processing.

10. Apparatus for fluid processing of a plurality of ophthalmic lenses in a tank of processing fluid, said apparatus including a carrier frame in which said lenses are contained during said fluid processing, wherein the improvement comprises:
a) means for rotating said carrier frame at least 90° in said tank following a first stage of said fluid processing of said lenses, and wherein said carrier frame remains submerged in said tank for a second stage of said fluid processing.

11. The apparatus of claim 10, Wherein said rotating means comprises a manually operated grappling device having at least one hook for engaging said carrier frame.

12. The apparatus of claim 11 wherein said carrier frame includes a rod extending along the length of said carrier frame, and wherein said hook is engaged with said rod to pull and rotate said carrier frame.

13. The apparatus of claim 10, and further comprising a plurality of processing units in which said lenses are contained, said processing units being removably inserted into said carrier frame during fluid processing of said lenses.

14. The apparatus of claim 13 wherein said processing units each comprise one or more pallets upon which said lenses are removably positioned.

15. The apparatus of claim 14, wherein said lenses are adhered to a respective mold section in which the lenses were formed prior to said fluid processing thereof, said mold sections being removably positioned in a pallet.

16. The apparatus of claim 15 wherein said mold section is a female mold section having a concave molding surface to which a respective lens is adhered, said female mold sections being positioned on a respective female mold pallet.

17. The apparatus of claim 16, and further comprising a male mold section associated with a respective said female mold section, said male mold section having a complimentary convex molding surface, said male mold sections being positioned on a respective male mold pallet placed in stacked relation to a respective female mold pallet with each respective pair of female and male mold surfaces lying in facing yet spaced relation in said carrier frame with a respective lens held therebetween, and wherein said spacing is sufficient to permit fluid to flow between each respective pair of male and female mold sections to reach and process the respective lens held therebetween.

18. The apparatus of claim 17 wherein said male mold sections lie beneath their respective said female mold sections when said carrier frame is rotated to said horizontal position whereby said lenses release form said respective female mold surfaces and migrate to their associated male mold surfaces during said second stage of fluid processing.

19. The apparatus of claim 18 and further comprising a third pallet placed in covering relation to said male mold pallet opposite said female mold pallet, said female, male and third pallets comprising a single one of said processing units.

20. The apparatus of claim 10 and further comprising means for circulating and filtering said fluid in said tank.

21. The apparatus of claim 10 and further comprising a pick-and-place unit for inserting and removing said carrier frame into and out of said tank.

22. The apparatus of claim 21 wherein said pick-and-place unit includes a plurality of fingers selectively movable between retracted and extended positions relative to each other, and wherein said carrier frame further includes a plurality of lifting rings which engage with said fingers of said pick-and-place unit when said fingers are in their extended position.

23. The apparatus of claim 22 wherein said pick-and-place unit is slidable along a track positioned above said tank, and further comprising means for selectively raising and lowering said pick-and-place unit over said tank.
